(19) United States
(12) Patent Application Publication
(10) Pub. No.: US 2014/0156731 A1
(43) Pub. Date: Jun. 5, 2014

(54) DATA QUERY SYSTEM FOR MOBILE DEVICE AND METHOD THEREOF

(71) Applicants: INVENTEC (PUDONG) TECHNOLOGY CORPORATION, Shanghai (CN); INVENTEC CORPORATION, Taipei (TW)

(72) Inventor: Sean LIU, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 13/803,320

(22) Filed: Mar. 14, 2013

(30) Foreign Application Priority Data
Nov. 30, 2012 (CN) 201210507347.6

(51) Int. Cl. H04L 29/06

(52) U.S. Cl. CPC H04L 67/42
USPC 709/203

(57) ABSTRACT

A data query system for a mobile device and a method thereof are provided. A server generates content information with at least an operation code with pre-specified content based on a short message format or an E-mail format, and when the server detects that Internet speed between the server and a mobile device is less than a preset value, the server provides the content information to the mobile device by short message or E-mail by a mobile communication network, so as to achieve the technical efficacy of data query by the mobile communication network when network connection between the mobile device and the server is in poor condition.

### BACKGROUND OF THE INVENTION

1. Field of the Invention

The present invention relates to a data query system and a method thereof, and more particularly to a data query system for a mobile device and a method thereof.

2. Description of Related Art

With the improvement of development of network technologies, more and more systems adopt network cloud applications, such as: a network translation system, a network hard disk service and network data query, and the network cloud applications bring convenience and fast services to a user.

The network cloud application may effectively reduce the consumption of client resources, and may make a client able to be lightweight, but the network cloud application is quite dependent on network connection between the client and a server. When Internet speed between the client and the server is too low, it invisibly causes that the user wastes too much time in waiting for the server to provide services, which causes inconvenience for the user at use.

Definitely, certain function services may be moved back to the client from a network cloud to process, but it also causes the problem that the consumption of the client resources increases and the client is overly huge. Therefore, whether further improvements of the network cloud may be proposed is one of the important projects in the development of the prior art.

To sum up, it can be known that in the prior art, the problem that a network cloud is overly dependent on connection speed between a client and a server exists for a long time, so it is necessary to propose improved technical means to solve this problem.

### SUMMARY OF THE INVENTION

In view of the problem that a network cloud is overly dependent on connection speed between a client and a server in the prior art, the present invention provides a data query system for a mobile device and a method thereof.

The data query system for a mobile device provided in the present invention includes: a mobile device and a server, where the mobile device further includes: a receiving module and a display module; and the server further includes: a generating module, a detecting module and a server transmitting module.

The receiving module of the mobile device is used for receiving content information with at least an operation code by a mobile communication network; and the display module of the mobile device is used for displaying the content information with the operation code.

The generating module of the server is used for generating the content information with the operation code with pre-specified content based on a short message format or an E-mail format; the detecting module of the server is used for detecting Internet speed between the server and the mobile device; and the server transmitting module of the server, is used for, when the server detects that the Internet speed between the server and the mobile device is less than a preset value, sending the content information to the receiving module by short message or E-mail by the mobile communication network.

The data query method for a mobile device provided in the present invention includes the following steps.

First, the server generates content information with at least an operation code with pre-specified content based on a short message format or an E-mail format; next, the server detects Internet speed between the server and a mobile device; next, when the server detects that the Internet speed between the server and the mobile device is less than a preset value, the server provides the content information to the mobile device by short message or E-mail by a mobile communication network; and finally, the mobile device displays the content information with the operation code by short message or E-mail.

The system and the method provided in present invention are described above, and the difference between the present invention and the prior art lies in that in the present invention, the server generates content information with at least an operation code with pre-specified content based on a short message format or an E-mail format, and when the server detects that Internet speed between the server and a mobile device is less than a preset value, the server provides the content information to the mobile device by short message or E-mail by a mobile communication network, so that a user may still obtain the pre-specified content from the server in a situation that network connection between the mobile device and the server is in poor condition.

Through the forgoing technical means, the present invention may achieve the technical efficacy of data query by a mobile communication network when network connection between a mobile device and a server is in poor condition.

### BRIEF DESCRIPTION OF THE DRAWINGS

The invention will become more fully understood from the detailed description given herein below illustration only, and thus is not limitative of the present invention, and wherein:

FIG. 1 is a block diagram of a data query system for a mobile device of the present invention.

FIG. 2A and FIG. 2B are flow charts of a data query method for a mobile device of the present invention.

FIG. 3 is a schematic view of a data query architecture for a mobile device of the present invention.

### DESCRIPTION OF THE EMBODIMENTS

Implementation manners of the present invention are illustrated in detail below with reference to accompanying drawings and embodiments, so the implementation procedure about how technical means is applied to the present invention to solve the technical problem and achieve the technical efficacy can be fully understood and implemented accordingly.

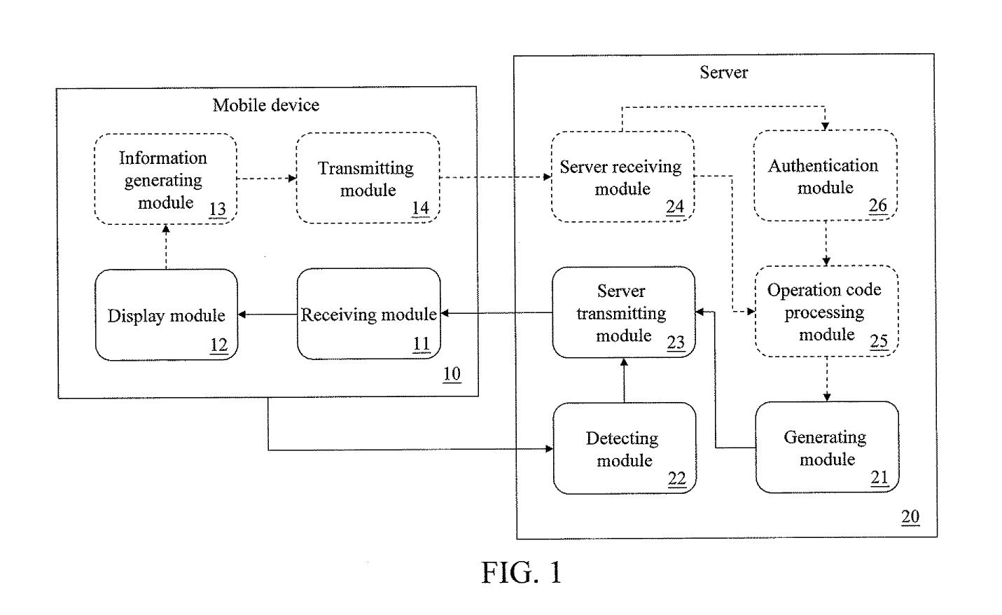

A data query system for a mobile device provided in the present invention is illustrated below first. Referring to FIG. 1, FIG. 1 is a block diagram of a data query system for a mobile device of the present invention.

The data query system for a mobile device provided by the present invention includes: a mobile device 10 and a server 20, where the mobile device 10 further includes: a receiving module 11 and a display module 12; and the server 20 further includes: a generating module 21, a detecting module 22 and a server transmitting module 23.

A user may pre-specify content in the server 20 (such as learning content, translation content and storage content, which is merely illustrated as examples herein, but is not intended to limit the application scope of the present invention). The generating module 21 of the server 20 generates the content information having an operation code with pre-specified content based on a short message (including a multi-media short message and a plain text short message) format or an E-mail format. A phone number in a short message and a mail box in an E-mail are pre-stored in the server 20, and the phone number and the mail box are corresponding to the mobile device 10. The operation code may be displayed in bottom right of the words of the pre-specified content and presented in a hyperlink form, which is merely illustrated as an example herein, but is not intended to limit the application scope of the present invention.

After the mobile device 10 establishes connection with the server 20 through the Internet, the detecting module 22 of the server 20 continuously detects Internet speed between the server 20 and the mobile device 10. When the detecting module 22 of the server 20 detects that the Internet speed between the server 20 and the mobile device 10 is less than a preset value, the server transmitting module 23 of the server 20 provides the content information, with the operation code, generated by the generating module 21 of the server 20 to the mobile device 10 by short message or E-mail by a mobile communication network.

The receiving module 11 of the mobile device 10 may receive, by the mobile communication network, the content information, with the operation code, provided by the server transmitting module 23 of the server 20. After the receiving module 11 of the mobile device 10 obtains the content information with the operation code from the server transmitting module 23 of the server 20 by the mobile communication network, the display module 12 of the mobile device 10 may display the content information, with the operation code, obtained by the receiving module 11 of the mobile device 10, so that the user may still obtains the pre-specified content from the server 20 in a situation that network connection between the mobile device 10 and the server 20 is in poor condition.

Next, the mobile device 10 further includes: an information generating module 13 and a transmitting module 14; and the server 20 further includes: a server receiving module 24, an operation code processing module 25 and an authentication module 26. When the user clicks the operation code in the content information, with the operation code, displayed by the display module 12 of the mobile device 10, the information generating module 13 of the mobile device 10 may generate response information with the operation code based on the short message format or the E-mail format. The phone number in the short message and the mail box in the E-mail are pre-stored in the mobile device 10 and the phone number and the mail box are corresponding to the server 20.

After the information generating module 13 of the mobile device 10 generates the response information with the operation code based on the short message format or the E-mail format, the transmitting module 14 of the mobile device 10 may provide the response information, with the operation code, generated by the information generating module 13 of the mobile device 10 to the server 20 by short message or E-mail by the mobile communication network.

The server 20 may obtain, through the server receiving module 24 of the server 20, the response information, with the operation code, provided by the transmitting module 14 of the mobile device 10. After the server receiving module 24 of the server 20 obtains the response information with the operation code, the operation code processing module 25 of the server 20 may obtain a query result corresponding to the operation code in the response information. The server 20 pre-establishes a comparison table or database where the operation code and inquiry result correspond to each other. The operation code processing module 25 of the server 20 may obtain the query result corresponding to the operation code through the pre-established comparison table or database.

After the operation code processing module 25 of the server 20 obtains the query result corresponding to the operation code, the generating module 21 of the server 20 may generate result information with the query result based on the short message format or the E-mail format. Next, the server transmitting module 23 of the server 20 provides the result information generated by the generating module 21 of the server 20 to the mobile device 10 by short message or E-mail by the mobile communication network.

The receiving module 11 of the mobile device 10 may receive, by the mobile communication network, the result information provided by the server transmitting module 23 of the server 20. After the receiving module 11 of the mobile device 10 obtains the result information from the server transmitting module 23 of the server 20 by the mobile communication network, the display module 12 of the mobile device 10 may display the result information obtained by the receiving module 11 of the mobile device 10, so that the user may still obtain the result information from the server 20 in a situation that network connection between the mobile device 10 and the server 20 is in poor condition, so as to achieve the efficacy of query data from the server 20.

Additionally, the information generating module 13 of the client 10 may further generate the response information with the operation code and an operation message based on the short message format or the E-mail format. After the information generating module 13 of the mobile device 10 generates the response information with the operation code and the operation message based on the short message format or is the E-mail format, the transmitting module 14 of the mobile device 10 may provide the response information, with the operation code and the operation message, generated by the information generating module 13 of the mobile device 10 to the server 20 by short message or E-mail by the mobile communication network.

The server 20 may obtain, through the server receiving module 24 of the server 20, the response information with the operation code and the operation message provided by the transmitting module 14 of the mobile device 10. After the server receiving module 24 of the server 20 obtains the response information with the operation code and the operation message, the operation code processing module 25 of the server 20 may execute a corresponding service function based on the operation code and the operation message in the response information, and the service function is such as adding new data, editing data, deleting data or sending a request to other clients 10, which is merely illustrated as an example herein, but is not intended to limit the application scope of the present invention.

And when the client 10 provides the response information with the operation code to the server 20 by the mobile communication network, the authentication module 26 of the server 20 may further authenticate the response information, namely, the authentication module 26 of the server 20 determines whether the phone number of the short message or the mail box of the E-mail is recorded in the server 20, which is merely illustrated as an example herein, but is not intended to limit the application scope of the present invention.

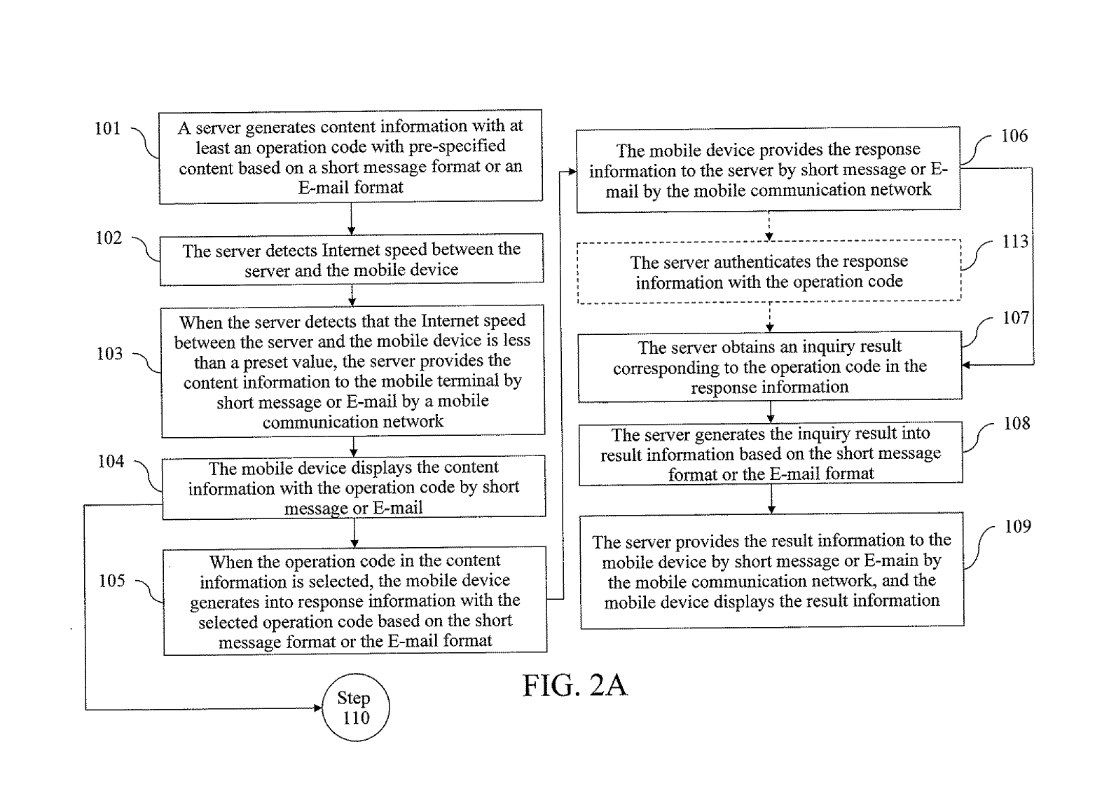

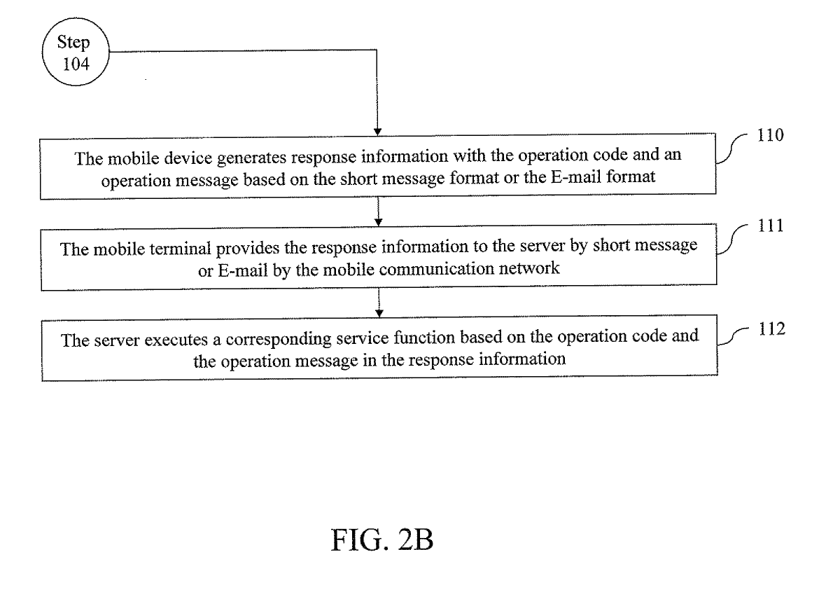

Next, operation manners and flows of the present invention are illustrated below through an embodiment, and the following embodiment is illustrated with reference to FIG. 1, FIG. 2A and FIG. 2B. FIG. 2A and FIG. 2B are flow charts of a data query method for a mobile device of the present invention.

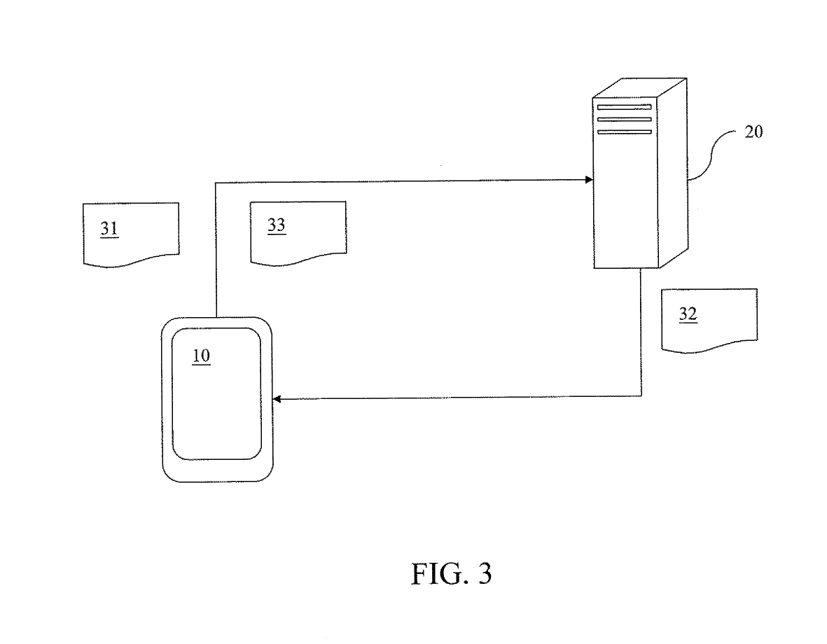

Referring to FIG. 3, FIG. 3 is a schematic view of a data query architecture for a mobile device of the present invention.

Assuming a user pre-specifies content being “This is a book.” in the server 20, an operation code being “Dr.eye_Message_{—}001” is established at bottom right of “book” in a hyperlink form, and a phone number being “0987654321” corresponding to the mobile device 10 of the user is pre-stored in the server 20, so that the generating module 21 of the server 20 generates the pre-specified content being “This is a book.” and the phone number being “0987654321” into content information 31 with the operation code being “Dr.eye_Message_{—}001” based on a short message format (step 101).

After the mobile device 10 establishes connection with the server 20 through the Internet, the detecting module 22 of the server 20 continuously detects Internet speed between the server 20 and the mobile device 10 (step 102). In this embodiment, the detecting module 22 of the server 20 detects that the Internet speed between the server 20 and the mobile device 10 is “0.1 Kbps” and an assumed preset value is “0.5 Kbps”. In this case, the detecting module 22 of the server 20 detects that the Internet speed between the server 20 and the mobile device 10 is “0.1 Kbps”, which is less than the preset value being “0.5 Kbps” (step 103).

In this case, the server transmitting module 23 of the server 20 provides the content information 31, with the operation code being “Dr.eye_Message_{—}001”, generated by the generating module 21 of the server 20 to the mobile device 10 by a mobile communication network by short message (step 103).

The receiving module 11 of the mobile device 10 may receive, by the mobile communication network, the content information 31, with the operation code being “Dr.eye_Message_{—}001”, provided by the server transmitting module 23 of the server 20.

After the receiving module 11 of the mobile device 10 obtains the content information 31 with the operation code being “Dr.eye_Message_{—}001” from the server transmitting module 23 of the server 20 by the mobile communication network, the display module 12 of the mobile device 10 may display the content information 31, with the operation code being “Dr.eye_Message_{—}001”, obtained by the receiving module 11 of the mobile device 10 (step 104), so that the user may still obtain the pre-specified content from the server 20 in a situation that network connection between the mobile device 10 and the server 20 is in poor condition.

When the user clicks the operation code being “Dr.eye_Message_{—}001” in the content information 31, with the operation code being “Dr.eye_Message_{—}001”, displayed by the display module 12 of the mobile device 10, the information generating module 13 of the mobile device 10 generates response information 32 with the operation code being “Dr.eye_Message_{—}001” based on the short message format (step 105), and a phone number being “0987123456” corresponding to the server 20 is pre-stored in the mobile device 10.

After the information generating module 13 of the mobile device 10 generates the response information 32 with the operation code being “Dr.eye_Message_{—}001” based on the short message format, the transmitting module 14 of the mobile device 10 may provide the response information 32, with the operation code being “Dr.eye_Message_{—}001”, generated by the information generating module 13 of the mobile device 10 to the server 20 by short message by the mobile communication network (step 106).

The server 20 may obtain, through the server receiving module 24 of the server 20, the response information 32, with the operation code being “Dr.eye_Message_{—}001”, provided by the transmitting module 14 of the mobile device 10. After the server receiving module 24 of the server 20 obtains the response information 32 with the operation code being “Dr.eye_Message_{—}001”, the operation code processing module 25 of the server 20 may obtain translation content being “book; book . . . ” being a query result corresponding to the operation code being “Dr.eye_Message_{—}001” in the response information 32 from a database (step 107).

After the operation code processing module 25 of the server 20 obtains the translation content being “book; book . . . ” being the query result corresponding to the operation code being “Dr.eye_Message_{—}001”, the generating module 21 of the server 20 may generate the translation content being “book; book . . . ” being the inquiry result and the phone number being “0987654321” corresponding to the mobile device 10 into result information 33 based on the short message format (step 108).

Next, the server transmitting module 23 of the server 20 provides the result information 33 generated by the generating module 21 of the server 20 to the mobile device 10 by short message by the mobile communication network (step 109).

The receiving module 11 of the mobile device 10 may receive, by the mobile communication network, the result information 33 provided by the server transmitting module 23 of the server 20. After the receiving module 11 of the mobile device 10 obtains the result information 33 by the mobile communication network from the server transmitting module 23 of the server 20, the display module 12 of the mobile device 10 may display the result information 33 obtained by receiving module 11 of the mobile device 10 (step 109), so that the user may still obtain the result information from the server 20 in a situation that network connection between the mobile device 10 and the server 20 is in poor condition, so as to achieve the efficacy of query data from the server 20.

Additionally, assuming the information generating module 13 of the client 10 generates response information 32 with the operation code being “Dr.eye_Friends_{—}03” and an operation message being “I am Zhang San, please add my MSN and my MSN is: zhangsan@hotmail.com” based on the short message format (step 110). After the information generating module 13 of the mobile device 10 generates the response information 32 with the operation code being “Dr.eye_Friends_{—}03” and the operation message being “I am Zhang San, please add my MSN and my MSN is: zhangsan@hotmail.com” based on the short message format, the transmitting module 14 of the mobile device 10 may provide the response information 32, with the operation code being “Dr.eye_Friends_{—}03” and the operation message being “I am Zhang San, please add my MSN and my MSN is: zhangsan@hotmail.com”, generated by the information generating module 13 of the mobile device 10 to the server 20 by short message or E-mail by the mobile communication network (step 111).

The server 20 may obtain, through the server receiving module 24 of the server 20, the response information 32, with the operation code being “Dr.eye_Friends_{—}03” and the operation message being “I am Zhang San, please add my MSN and my MSN is: zhangsan@hotmail.com”, provided by the transmitting module 14 of the mobile device 10. After the server receiving module 24 of the server 20 obtains the response information 32 with the operation code being “Dr.eye_Friends_{—}03” and the operation message being “I am Zhang San, please add my MSN and my MSN is: zhangsan@hotmail.com”, the operation code processing module 25 of the server 20 may send a message being “I am Zhang San, please add my MSN and my MSN is: zhangsan@hotmail.com” to other client 10 (namely, a third friend of the client 10) based on the operation code being “Dr.eye_Friends_{—}03” and the operation message being “I am Zhang San, please add my MSN and my MSN is: zhangsan@hotmail.com” in the response information (step 112).

Further, when the client 10 provides the response information 32 with the operation code to the server 20 by the mobile communication network, the authentication module 26 of the server 20 may further authenticate the response information 32, namely, the authentication module 26 of the server 20 determines whether the phone number being “0987654321” of the short message is recorded in the server 20. In this embodiment, the phone number being “0987654321” of the client 10 passes the authentication of the authentication module 26 of the server 20 (step 113).

To sum up, it can be known that, the difference between the present invention and the prior art lies in that in the present invention, a server generates content information with at least an operation code with pre-specified content based on a short message format or an E-mail format, and when the server detects that Internet speed between the server and a mobile device is less than a preset value, the server provides the content information to the mobile device by short message or E-mail by a mobile communication network, so that a user may still obtain the pre-specified content from the server in a situation that network connection between the mobile device and the server is in poor condition.

The technical means may be used for solving the problem existing in the prior art that a network cloud is overly dependent on connection speed between a client and a server, and further achieving the technical efficacy of data query by the mobile communication network when network connection between the mobile device and the server is in poor condition.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A data query system for a mobile device, comprising:
a mobile device, wherein the mobile device further comprises:
a receiving module, used for receiving content information with at least an operation code by a mobile communication network; and
a display module, used for displaying the content information with the operation code; and
a server, wherein the server further comprises:
a generating module, used for generating the content information with the operation code with pre-specified content based on a short message format or an E-mail format;
a detecting module, used for detecting Internet speed between the server and the mobile device; and
a server transmitting module, used for, when the server detects that the Internet speed between the server and the mobile device is less than a preset value, sending the content information to the receiving module by short message or E-mail by the mobile communication network.

2. The data query system for a mobile device according claim 1, wherein:
the receiving module of the mobile device is further used for receiving result information;
the display module of the mobile device is further used for displaying the result information;
the mobile device further comprises:
an information generating module, used for, when the operation code in the content information is selected, generating response information with the operation code based on the short message format or the E-mail format; and
a transmitting module, used for sending the response information by short message or E-mail by the mobile communication network;
the server further comprises:
a server receiving module, used for receiving the response information with the operation code by the mobile communication network; and
an operation code processing module, used for obtaining an query result corresponding to the operation code in the response information;
the generating module of the server is further used for generating the result information with the query result based on the short message format or the E-mail format; and
the server transmitting module of the server is further used for sending the result information to the receiving module by the mobile communication network.

3. The data query system for a mobile device according claim 2, wherein the information generating module is further used for generating the response information with the operation code and an operation message based on the short message format or the E-mail format, so that the operation code processing module executes a corresponding service function based on the operation code and the operation message in the response information.

4. The data query system for a mobile device according claim 1, wherein the server further comprises an authentication module, used for authenticating the response information with the operation code.

5. A data query method for a mobile device, comprising:
generating content information with at least an operation code based on a short message format or an E-mail format by server;
detecting Internet speed between the server and a mobile device by the server;
sending the content information from the server to the mobile device by short message or E-mail by a mobile communication network when the server detects that the Internet speed between the server and the mobile device is less than a preset value; and
displaying the content information with the operation code by short message or E-mail on the mobile device.

6. The data query method for a mobile device according claim 5, further comprising:
generating response information with the operation code by the mobile device based on the short message format or the E-mail format when the operation code in the content information is selected;
sending the response information from the mobile device to the server by short message or E-mail by the mobile communication network;
obtaining a query result corresponding to the operation code in the response information by the server;
generating the result information with the query result by server based on the short message format or the E-mail format; and
sending the result information from the server to the mobile device by short message or E-mail by the mobile communication network, and displaying the result information on the mobile device.

7. The data query method for a mobile device according claim 6, further comprising:
generating the response information with the operation code and an operation message by the mobile device based on the short message format or the E-mail format;
sending the response information from the mobile device to the server by short message or E-mail by the mobile communication network; and
executing a corresponding service function by the server based on the operation code and the operation message in the response information.

8. The data query method for a mobile device according claim 5, further comprising authenticating the response information with the operation code by the server.
